(19) United States
(12) Patent Application Publication
(10) Pub. No.: US 2025/0269836 A1
(43) Pub. Date: Aug. 28, 2025

(54) METHOD FOR OPERATING A MOTOR VEHICLE HAVING A HYBRID DRIVE

(71) Applicant: Robert Bosch GmbH, Stuttgart (DE)

(72) Inventors: Christopher Wollgarten, Rayong (TH); Felix Raab, Stuttgart (DE); Frederic Seidel, Hagenbach (DE); Gerhard Troestl, Wien (AT); Michael Bachner, Stuttgart (DE)

(21) Appl. No.: 19/066,256

(22) Filed: Feb. 28, 2025

(30) Foreign Application Priority Data
Feb. 28, 2024 (DE) 10 2024 201 834.1

(51) Int. Cl. B60W 20/40; B60W 10/06; B60W 20/16

(52) U.S. Cl. CPC B60W 20/40; B60W 10/06; B60W 20/16; B60W 2510/068

(57) ABSTRACT

Method for operating a motor vehicle (10) having a hybrid drive, wherein the motor vehicle (10) comprises a first drive (12) having an electric motor (14) associated with an electrical energy store (16), and a second drive as an internal combustion engine (22) having an exhaust aftertreatment system, in particular having at least one catalyst (24),
wherein permanent monitoring for detecting a low-load phase for the drive of the motor vehicle (10) is performed,
wherein monitoring of a temperature for the exhaust aftertreatment system, in particular a temperature for the at least one catalyst (24) of the exhaust aftertreatment system, is performed as a function of the detected low-load phase,
wherein further operation or deactivation of the internal combustion engine (20) is performed as a function of a critical temperature (Tₖᵣᵢₜ) for the exhaust aftertreatment system and a modeled cooling of the exhaust gas treatment system.

### BACKGROUND

The invention relates to a method for operating a motor vehicle having a hybrid drive as well as a control unit and a computer program for carrying out said method.

Motor vehicles having a hybrid drive, also referred to as a hybrid vehicle, are vehicles that have at least two drives. Typically, hybrid vehicles are configured as hybrid electric vehicles that are driven from at least one electric vehicle and another energy converter or engine. Such a vehicle draws energy from both an electrical store, typically an accumulator or battery, and an additionally carried fuel.

With the increasing spread of supporting electric drives, it is possible to operate the vehicle purely electrically and to switch off the internal combustion engine completely, e.g., when driving in a city with a low power demand (low speed).

When dropping below a critical threshold of the catalyst temperature, appropriate heating measures must be reintroduced to ensure a functioning exhaust system and thus compliance with emissions targets.

### SUMMARY

In a first aspect, the invention relates to a method for operating a motor vehicle having a hybrid drive, wherein the motor vehicle is associated with a first drive having an electric motor, and comprises a second drive as an internal combustion engine with an exhaust aftertreatment system, in particular with at least one catalyst,
wherein monitoring of a temperature for the exhaust aftertreatment system, in particular a temperature for the at least one catalyst of the exhaust aftertreatment system, is performed as a function of the detected low-load phase,
wherein further operation or deactivation of the internal combustion engine is performed as a function of a critical temperature for the exhaust aftertreatment system and a modeled cooling of the exhaust gas treatment system.

The method has the particular advantage that by purely using the electric motor and deactivating the internal combustion engine in low-load phases in which the exhaust aftertreatment system would drop below the critical temperature, cooling of the exhaust aftertreatment system, in particular the catalysts, can be avoided due to cold exhaust gas flowing through. Thus, cooling of the catalysts is avoided and thus the need for fuel-intensive heating measures is reduced. This results in an improved energy balance of the system and emissions reduction. Thus, compared to the prior art, the method allows for more efficient use of the exhaust aftertreatment system and emissions reduction.

In a particular configuration, a cooling behavior of the exhaust aftertreatment system is modeled using an exhaust temperature.

Advantageously, the feature of the claim that the cooling behavior of the exhaust aftertreatment system is modeled by means of an exhaust temperature allows more precise monitoring of the exhaust temperature and thus more effective prevention of cooling of the catalyst during low-load phases. This allows heating measures to be used more effectively and purposefully to maintain emissions conversion, resulting in an improved energy balance of the system.

In an alternative configuration, a duration of the detected low-load phase for the motor vehicle and a cooling of the exhaust aftertreatment system for the duration of the low-load phase are determined,
wherein if the temperature of the exhaust aftertreatment system does not drop below the critical temperature for the determined duration of the low-load phase, the internal combustion engine is deactivated.

The term duration may be understood as the temporal length of a particular event or state. In the context of the present patent application, the duration refers to the length of the detected low-load phase of the motor vehicle, as well as the cooling of the exhaust aftertreatment system during this phase. The duration is determined by analyzing the relevant data, such as predictive data. The duration can thus be considered a temporal variable that is critical for carrying out the described method.

In an advantageous configuration, a duration of the detected low-load phase for the motor vehicle and cooling of the exhaust aftertreatment system for the duration of the low-load phase are determined,
wherein if the temperature of the exhaust aftertreatment system drops below the critical temperature for the determined duration of the low-load phase, appropriate heating measures for the exhaust aftertreatment system are activated.

In an alternative configuration, the internal combustion engine is deactivated within the determined duration of the low-load phase and subsequently reactivated.

This ensures that emissions conversion can be maintained without wasting energy unnecessarily. Thus, compared to the prior art, it will be possible to perform more efficient and targeted control of the catalyst heating measures, resulting in an improved energy balance and higher effectiveness of emissions conversion.

In a further embodiment, the duration of the low-load phase is determined by predictive data.

This has the particular advantage that this can be better predicted when the internal combustion engine should be stopped in order to avoid cooling of the catalysts. This leads to a more efficient use of the heating measures and thus to an improved energy balance of the system. Compared to the prior art, in which the duration of the low-load phase is estimated based only on engine load and exhaust temperature, the predictive data feature allows for a more accurate prediction and thus better control over the operation of the system.

In one advantageous configuration, heating of the exhaust aftertreatment system is performed by internal engine heating measures and/or by activating electric heaters.

It is advantageous if the exhaust aftertreatment system can be heated by internal engine heating measures and/or by activating electric heaters.

In another configuration, the temperature of the exhaust aftertreatment system is determined as a function of at least one variable selected from a group consisting of: State of the internal combustion engine, load of the internal combustion engine, speed of the internal combustion engine, ignition angle efficiency, lambda split setting, vehicle speed, ambient temperature, late injection parameter.

In a particular configuration, the internal combustion engine is restarted when the temperature of the exhaust aftertreatment system, particularly the at least one catalyst, drops below the critical temperature.

In an advantageous embodiment, the predictive data is selected from a group consisting of: wheel power of the motor vehicle, navigation data, traffic data, charging state of the electrical energy store.

By using this data, the system can more accurately characterize the low-load phases of the internal combustion engine and optimize the timing of engine shutdown to avoid cooling of the catalysts. This leads to an improved energy balance of the system as unnecessary heating measures can be avoided. Compared to the prior art, which may only use a few parameters to characterize the low-load phases, the feature of the claim enables more precise and efficient control of the system.

In further aspects, the invention relates to an apparatus, in particular a control unit and a computer program, configured and in particular programmed so as to carry out any one of the methods. In yet another aspect, the invention relates to a machine-readable storage medium on which the computer program is stored.

### BRIEF DESCRIPTION OF THE DRAWINGS

FIG. 1 is a schematic representation of a vehicle with an embodiment of the arrangement to perform the method.

FIG. 2 shows a flow chart of a possible sequence of the presented method.

### DETAILED DESCRIPTION

The invention is illustrated schematically in the drawings on the basis of embodiments and is described in the following with reference to said drawings.

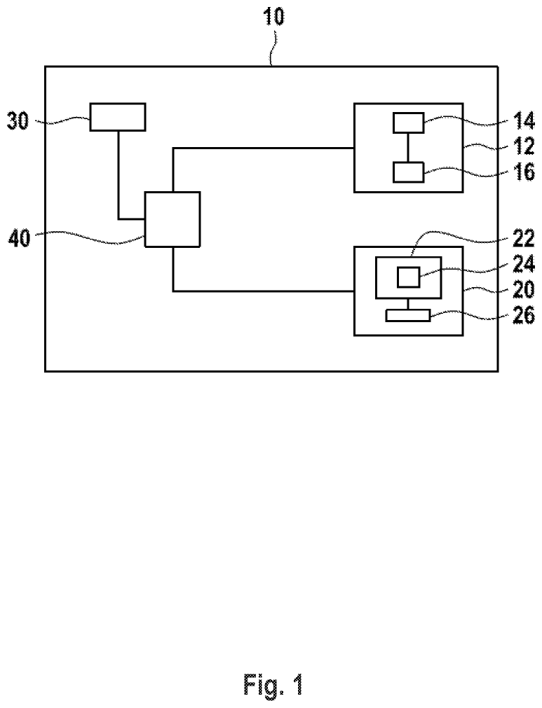

FIG. 1 shows a schematic, highly simplified representation of a motor vehicle, which is denoted overall by reference sign 10. This motor vehicle 10 comprises a first drive 12 having an electric motor 14 as well as an associated electrical store 16 and an internal combustion engine 22, wherein the internal combustion engine comprises an exhaust aftertreatment system. The exhaust aftertreatment system comprises at least one catalyst 24. In alternative embodiments, the exhaust aftertreatment system may also consist of a plurality of different components, such as a selective catalytic exhaust aftertreatment system (SCR) and/or one or more catalysts 24. Furthermore, the motor vehicle 10 comprises a temperature model T_{mod} for determining the temperature of the exhaust aftertreatment system. In so doing, the temperature model may be configured such that temperatures may also be determined for certain components of the exhaust aftertreatment system. This temperature model may be modularly adapted to the particular configuration of the system and the particular components included therein. In a preferred configuration, a temperature sensor is arranged in the exhaust gas line downstream of the internal combustion engine. Alternatively or in addition, temperature sensors may be arranged in the components of the exhaust aftertreatment system.

Furthermore, the motor vehicle 10 comprises a fuel tank 26.

Furthermore, the illustration shows a navigation system 30 in which the driver provides information on the target address and, if necessary, route preferences and which may determine a route to that destination. In principle, an input from which a travel duration or a travel route can then be calculated can also be made in another way, for example by directly entering a travel route length.

In addition, an arrangement is depicted in the illustration, which is indicated overall with the reference numeral 40. This arrangement 40, which is e.g. configured as a control unit of the motor vehicle 10, detects predictive data that allows a remaining requirement for energy to reach the predetermined target and a remaining availability of energy to be determined taking into account the charging state of the energy store 16. As a result, the internal combustion engine 20 is stopped, i.e., switched off, for example. The control unit 40 may further evaluate the topology, traffic information of the selected route for internal calculations.

The term low-load phase may be understood as a phase in which the motor vehicle has only a low load and the internal combustion engine provides little power. During this phase, the exhaust aftertreatment system is not sufficiently heated to operate effectively. Cooling the exhaust aftertreatment system during the low-load phase may lead to degradation of emissions levels. Therefore, it is important to determine the duration of the low-load phase and selectively heat the exhaust aftertreatment system during that time to ensure optimal performance. The duration of the low-load phase may be determined by predictive data, which may be from various sources such as the wheel power of the vehicle, navigation data, traffic data, and the charging state of the electrical energy storage.

Advantageously, the feature of the claim allows the duration of the detected low-load phase for the motor vehicle and the cooling of the exhaust aftertreatment system for the duration of the low-load phase to be determined. As a result, the internal combustion engine may be switched off during extended periods of low-load phases to avoid cooling of the exhaust aftertreatment system, thus reducing or eliminating the need for heating measures.

The term navigation data may be understood as information used to determine the optimal route of a motor vehicle. For example, this data may include the geographic location of the vehicle, the location of the destination, the road conditions, traffic information, and other relevant information. Navigation data may be from various sources, such as from a GPS system, a cell phone, or a navigation system in the vehicle itself. They are used to recommend the best possible route to the driver and can also help optimize driving behavior and reduce emissions by allowing the vehicle to adjust the route and speed accordingly.

The term traffic data may be understood as information about road traffic, which may be collected from various sources. For example, this data may include information about traffic density, speed of vehicles, number of vehicles on the roadway, and direction of traffic flow. Traffic data may be collected from various sources, such as traffic monitoring cameras, GPS systems in vehicles, or cell towers that track the movements of cell phones. This data can then be used to analyze traffic patterns and identify traffic issues to avoid or reduce traffic jams. With respect to the described patent, traffic data can be used to generate predictive data that can be incorporated into the method for reducing emissions of motor vehicles.

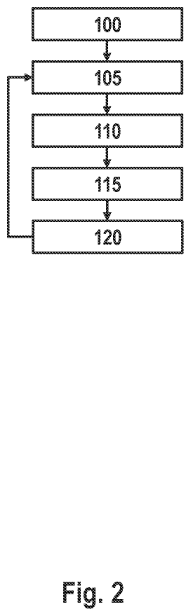

FIG. 2 shows a flow chart of a possible sequence of the presented method.

In a first step 100, the journey begins with a driver entering destination into a navigation device.

The method then continues in a step 105.

In a step 105, detection of low-load phases is continuously performed by control unit 40. For this purpose, the control unit 40 advantageously monitors several input variables of the motor vehicle 10, such as an engine load, a speed n_{eng}, the accelerator pedal position, or similar variables that allow a conclusion to be drawn about a low-load phase.

If a low load phase is detected, the method continues in a step 110.

In a step 110, a duration for the low-load phase is determined using a model stored on the control unit 40 and the use of the predictive data. The duration here indicates the modeled time for how long the motor vehicle 10 will still be traveling in the low-load phase.

The method then continues in a step 115.

In a step 115, based on the current temperature for the exhaust aftertreatment system for the determined duration of the low-load phase, the cooling of the exhaust aftertreatment system is modeled.

It is to be assumed that in continuous low-load phases, a sufficiently high heat energy input is not entered into the exhaust gas line, and that an accelerated cooling of the exhaust aftertreatment system is furthermore created by an ongoing exhaust mass flow (\dot{m}ₑₓₕ).

For this purpose, a modeled temperature T_{kat,mod} is determined which corresponds to the temperature of the exhaust aftertreatment system towards the end of the duration of the low-load phase.

The method then continues in a step 120.

In a step 120, the control unit 40 checks whether the modeled temperature T_{kat, mod} of the exhaust aftertreatment system is below a critical temperature Tₖᵣᵢₜ for the exhaust aftertreatment system.

The critical temperature preferably Tₖᵣᵢₜ describes a light-off temperature for the at least one catalyst 24 of the exhaust aftertreatment system. The critical temperature Tₖᵣᵢₜ for the exhaust aftertreatment system may preferably be provided in an application phase for the motor vehicle 10.

If the modeled temperature T_{kat,mod} exceeds the critical temperature Tₖᵣᵢₜ, the still activated internal combustion engine 20 can be switched off and the motor vehicle can be purely electrically operated by the first drive 12.

Shutting down the internal combustion engine 22 may conserve fuel and conserve emissions.

When the modeled temperature T_{kat,mod} drops below the critical temperature Tₖᵣᵢₜ, various heating measures may be performed for the exhaust aftertreatment system.

For example, internal engine heating measures such as after-injection of fuel may be performed to generate waste heat in the exhaust gas line to heat the exhaust aftertreatment system.

Alternatively, if e.g. a catalyst with electric heating discs is installed (eCat), the temperature in the exhaust aftertreatment system is increased by activation of the electric heating discs.

In an alternative configuration, the internal combustion engine 20 may be deactivated, and from the time of dropping below the critical temperature Tₖᵣᵢₜ by the modeled temperature T_{kat,mod} of the catalyst 24, a heating action may be activated and cooling of the exhaust aftertreatment system prevented.

Furthermore, by shutting down the internal combustion engine 22, the exhaust mass flow \dot{m}ₑₓₕ is significantly reduced, resulting in less cooling of the exhaust aftertreatment system.

The method may then be terminated or continued in step 105.

1. A method for operating a motor vehicle (10) having a hybrid drive, wherein the motor vehicle (10) comprises a first drive (12) having an electric motor (14) associated with an electrical energy store (16), and a second drive as an internal combustion engine (22) having an exhaust aftertreatment system,
wherein the method comprises:
detecting a low-load phase for the drive of the motor vehicle (10), and
monitoring a temperature for the exhaust aftertreatment system as a function of the detected low-load phase,
wherein further operation or deactivation of the internal combustion engine (20) is performed as a function of a critical temperature (Tₖᵣᵢₜ) for the exhaust aftertreatment system and a modeled cooling of the exhaust gas treatment system.

2. The method according to claim 1, wherein a cooling behavior of the exhaust aftertreatment system is modeled using an exhaust temperature (Tₑₓₕ).

3. The method according to claim 1, wherein a duration of the detected low-load phase for the motor vehicle (10) and a cooling of the exhaust aftertreatment system for the duration of the low-load phase is determined,
wherein, if the temperature of the exhaust aftertreatment system does not drop below the critical temperature (Tₖᵣᵢₜ) for the determined duration of the low-load phase, the internal combustion engine (22) is deactivated.

4. The method according to claim 1, wherein a duration of the detected low-load phase for the motor vehicle (10) and the cooling of the exhaust aftertreatment system for the duration of the low-load phase is determined,
wherein if the temperature of the exhaust aftertreatment system drops below the critical temperature (Tₖᵣᵢₜ) for the determined duration of the low-load phase, appropriate heating measures for the exhaust aftertreatment system are activated.

5. The method according to claim 4, wherein the internal combustion engine (22) is deactivated within the determined duration of the low-load phase and subsequently reactivated.

6. The method according to claim 2, wherein the duration of the low-load phase is determined by predictive data.

7. The method according to claim 4, wherein heating of the exhaust aftertreatment system is performed by internal engine heating measures and/or by activating electric heaters.

8. The method according to claim 1, wherein the temperature of the exhaust aftertreatment system is determined as a function of at least one variable selected from a group consisting of:
state of the internal combustion engine (22), load of the internal combustion engine (22), speed of the internal combustion engine (22), ignition angle efficiency, lambda split setting, vehicle speed, ambient temperature, late injection parameter.

9. The method according to claim 4, wherein the internal combustion engine (22) is restarted if the temperature of the exhaust aftertreatment system drops below the critical temperature (T_{□□□□}).

10. The method according to claim 1, wherein the predictive data is selected from a group consisting of: wheel power of the motor vehicle, navigation data, traffic data, charging of the electrical energy store (16).

11. A non-transitory, machine-readable storage medium containing instructions that when executed by a computer cause the computer to control a motor vehicle (10) having a hybrid drive, wherein the motor vehicle (10) comprises a first drive (12) having an electric motor (14) associated with an electrical energy store (16), and a second drive as an internal combustion engine (22) having an exhaust aftertreatment system, by
detecting a low-load phase for the drive of the motor vehicle (10), and
monitoring a temperature for the exhaust aftertreatment system as a function of the detected low-load phase,
wherein further operation or deactivation of the internal combustion engine (20) is performed as a function of a critical temperature (T_{□□□□}) for the exhaust aftertreatment system and a modeled cooling of the exhaust gas treatment system.

12. A control unit (40), which is configured to perform a method according to claim 1.
